(19) United States
(12) Patent Application Publication
(10) Pub. No.: US 2026/0095260 A1
(43) Pub. Date: Apr. 2, 2026

(54) Systems and Methods for Nerve Reading and Image Reconstruction

(71) Applicant: Moshe OFER, Ramat Hasharon (IL)

(72) Inventor: Moshe OFER, Ramat Hasharon (IL)

(21) Appl. No.: 19/240,309

(22) Filed: Jun. 17, 2025

Related U.S. Application Data
(60) Provisional application No. 63/700,696, filed on Sep. 29, 2024.
(60) Provisional application No. 63/718,660, filed on Nov. 10, 2024.

(51) Int. Cl. H04B 13/00; H04N 5/907

(52) U.S. Cl. CPC H04B 13/005; H04N 5/907

(57) ABSTRACT

At least one nerve bundle connects between a subject's brain and at least one eye of the subject. A limiting arrangement is deployed relative to the subject and a scene within the field of view of the subject. The limiting arrangement allows, at each instance of a first sequence of instances, a different part of the scene to be viewed by the at least one eye. A processing subsystem receives, for each instance of the first sequence of instances, a first signal value that corresponds to a nerve impulse transmission along the at least one nerve bundle in response to the subject viewing the part of the scene. The processing subsystem determines, for each first signal value, a corresponding pixel value. The determination is based on a plurality of pixel values and a plurality of signal values stored in a storage.

### APPLICATION FOR PATENT

### CROSS-REFERENCE TO RELATED APPLICATIONS

This application claims priority from U.S. Provisional Ser. No. 63/700,696, filed Sep. 29, 2024, and U.S. Provisional Ser. No. 63/718,660 , filed Nov. 10, 2024, both disclosures of which are incorporated by reference in their entireties herein.

### TECHNICAL FIELD

The present disclosure relates to vision, hearing, and imagination in animal subjects.

### BACKGROUND OF THE INVENTION

The human vision system comprises the eyes, the brain, and parts of the nervous system. In general, light is sensed by photoreceptors (rods and cones) in the eye, and are converted into pulses that are transmitted to the brain by the optic nerve, to be interpreted by the brain as sight and vision. The human auditory system comprises the ears, the brain, and parts of the nervous system. In general, mechanical waves (vibrations) are detected by the ear and transduced (converted) into nerve pulses that are transmitted to the brain by a nerve or nerves, to be interpreted and perceived by the brain as sound. Imagination is the ability to for concepts, including objects and sensations, in the mind without any immediate input from the senses. These concepts can be in the form of, for example, mental images, phonological passages (i.e., non-acoustic sounds), analogies, and narratives.

### SUMMARY OF THE INVENTION

Aspects of the present disclosed subject matter, also referred to herein as the disclosure, provide methods and systems for nerve reading and image reconstruction.

According to the teachings of an embodiment of the present disclosure, there is provided a method for use with a subject having, a brain, at least one eye, and at least one nerve bundle connecting between the brain and the at least one eye. The method comprises: at each instance of a first sequence of instances, allowing a different part of a scene within the field of view of the subject to be viewed by the at least one eye; receiving, for each instance of the first sequence of instances, a first signal value that corresponds to a nerve impulse transmission along the at least one nerve bundle in response to the subject viewing the part of the scene; and determining, for each first signal value, a corresponding pixel value based on: a plurality of pixel values and a plurality of signal values stored in a storage medium.

Optionally, the plurality of pixel values stored in the storage medium are derived from a subset of pixels of an image presented to the subject over a second sequence of instances, the image including a plurality of pixels each assuming a pixel value, the pixel value of all pixels of the image outside of the subset held constant over the second sequence of instances, and at each subsequent instance in the second sequence of instances the pixel value of the pixels in the subset is changed relative to the pixel value at a previous instance in the second sequence of instances, and each signal value of the plurality of signal values measured at a respective instance of the second sequence of instances, each signal value of the plurality of signal values corresponding to a nerve impulse transmission along the at least one nerve bundle in response to the subject viewing the image.

Optionally, the subset of the pixels includes a single pixel.

Optionally, the pixel value of all pixels of the image outside of the subset is held constant over the second sequence of instances such that the pixels outside of the subset are presented as white or black.

Optionally, allowing a different part of a scene within the field of view of the subject to be viewed by the at least one eye includes: providing a limiting arrangement relative to the subject and the scene, the limiting arrangement sequentially limiting different parts of the scene over the second sequence of instances from reaching the at least one eye such that different parts of the scene are sequentially viewable by the at least one eye.

Optionally, the limiting arrangement includes a partially transparent display.

Optionally, the limiting arrangement includes a holographic display.

Optionally, determining the corresponding pixel for each first signal value includes fitting each first signal value to a curve that represents a relationship between the plurality of pixel values and the plurality of signal values.

Optionally, fitting each first signal value to the curve includes performing one or more of: interpolation, extrapolation, and regression.

Optionally, method further comprises: reconstructing an image of the scene from the determined corresponding pixel value for each first signal value, the reconstructed image of the scene being representative of what the subject sees when viewing the scene with the at least one eye.

There is also provided according to the teachings of an embodiment of the present disclosure a system for use with a subject having, a brain, at least one eye, and at least one nerve bundle connecting between the brain and the at least one eye. The system comprises: a limiting arrangement deployed relative to the subject and a scene within the field of view of the subject, the limiting arrangement configured to allow, at each instance of a first sequence of instances, a different part of the scene to be viewed by the at least one eye; and a processing subsystem configured to: receive, for each instance of the first sequence of instances, a first signal value that corresponds to a nerve impulse transmission along the at least one nerve bundle in response to the subject viewing the part of the scene, and determine, for each first signal value, a corresponding pixel value based on: a stored plurality of pixel values and plurality of signal values stored in a storage.

Optionally, the system further comprises: a storage medium in communication with the processing subsystem, the storage medium storing the plurality of pixel values and the plurality of second signal values, the plurality of pixel values derived from a subset of pixels of an image presented to the subject over a second sequence of instances, the image including a plurality of pixels each assuming a pixel value, the pixel value of all pixels of the image outside of the subset held constant over the second sequence of instances, and at each subsequent instance in the second sequence of instances the pixel value of the pixels in the subset is changed relative to the pixel value at a previous instance in the second sequence of instances, and each signal value of the plurality of signal values measured at a respective instance of the second sequence of instances, each signal value of the plurality of signal values corresponding to a nerve impulse transmission along the at least one nerve bundle in response to the subject viewing the image.

Optionally, the subset of the pixels includes a single pixel.

Optionally, the pixel value of all pixels of the image outside of the subset is held constant over the second sequence of instances such that the pixels outside of the subset are presented as white or black.

Optionally, the limiting arrangement sequentially limits different parts of the scene over the first sequence of instances from reaching the at least one eye such that different parts of the scene are sequentially viewable by the at least one eye.

Optionally, the limiting arrangement includes a partially transparent display.

Optionally, the limiting arrangement includes a holographic display.

Optionally, the processing subsystem is configured to determine the corresponding pixel for each first signal value by fitting each first signal value to a curve that represents a relationship between the plurality of pixel values and the plurality of signal values.

Optionally, fitting each first signal value to the curve includes the processing subsystem performing one or more of: interpolation, extrapolation, and regression.

Optionally, the processing subsystem is further configured to reconstruct an image of the scene from the determined corresponding pixel value for each first signal value, the reconstructed image of the scene being representative of what the subject sees when viewing the scene with the at least one eye.

There is also provided according to the teachings of an embodiment of the present disclosure a method for use with a subject having, a brain, at least one eye, and at least one nerve bundle connecting between the brain and the at least one eye. The method comprises: presenting an image to the subject at a first sequence of instances, the image including a plurality of pixels each assuming a pixel value, and the image presented to the subject such that: i) all but a subset of the pixels are held at a constant pixel value over the first sequence of instances, and ii) at each subsequent instance in the first sequence of instances the pixel value of the pixels in the subset of pixels is changed relative to the pixel value at a previous instance in the first sequence of instances such that there is a plurality of pixel values corresponding to the first sequence of instances; receiving, for each instance of the first sequence of instances, a first signal value that corresponds to a nerve impulse transmission along the at least one nerve bundle in response to the subject viewing the pixel, such that there is a plurality of first signal values corresponding to the plurality of pixel values; and storing, in a storage medium, the plurality of pixel values and the plurality of first signal values.

Optionally, the method further comprises: at each instance of a second sequence of instances, allowing a different part of a scene within the field of view of the subject to be viewed by the at least one eye; receiving, for each instance of the second sequence of instances, a second signal value that corresponds to a nerve impulse transmission along the at least one nerve bundle in response to the subject viewing the part of the scene; and determining, for each second signal value, a corresponding pixel value based on the stored plurality of pixel values and the plurality of first signal values.

Unless otherwise defined herein, all technical and/or scientific terms used herein have the same meaning as commonly understood by one of ordinary skill in the art to which the disclosure pertains. Although methods and materials similar or equivalent to those described herein may be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present disclosure are herein described, by way of example only, with reference to the accompanying drawings. With specific reference to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Attention is now directed to the drawings, where like reference numerals or characters indicate corresponding or like components. In the drawings:

FIG. 1 is a schematic representation of a system for use with a subject, according to embodiments of the present disclosure;

FIG. 2 is a block diagram of the processing subsystem of FIG. 1, showing a processing subsystem of the system as exemplarily including a processing device, according to an embodiment of the present disclosure;

FIG. 3 is a schematic representation of an example deployment of the processing subsystem of FIGS. 1 and 2 in which the processing device interfaces with a visual processing region of the brain of the subject via implantation at the optic nerves, according to an embodiment of the present disclosure;

FIG. 4 is a schematic representation of an exemplary wired interface that includes an electrode array that can be used for interfacing between the processing subsystem and the visual processing region of the brain of the subject, according to an embodiment of the present disclosure;

FIG. 5 is a schematic representation of a network system environment in which the system can operate according to embodiments of the disclosure;

FIG. 6 is a flow diagram showing steps of a method for building-up a database and reconstructing images of a scene, according to one set of embodiments of the present disclosure;

FIG. 7 is a flow diagram showing steps of a method for building-up a database and reconstructing images of a scene, according to another set of embodiments of the present disclosure;

FIG. 8A is a representation of a central field of view of a scene as viewed by a subject;

FIGS. 8B-8D are representations of the central view of the scene of FIG. 8A when being obstructed by a limiting arrangement that allows light from only a small part of the scene to reach the subject;

FIGS. 9A and 9B are representations of different respective sub-divisions of a display area of a display device of the system according to an embodiment of the present disclosure; and

FIG. 10 is a schematic representation of an exemplary non-invasive deployment configuration for externally interfacing between the processing subsystem and the visual processing region of the brain of the subject, according to an embodiment of the present disclosure.

### DESCRIPTION OF THE PREFERRED EMBODIMENTS

Embodiments of the present disclosure are directed to systems and methods, for use with subjects having a brain and at least one eye, which provide nerve reading and image reconstruction. Certain embodiments of the present disclosure provide methods that rely on formation of data (e.g., images) that originate from measurements of nerve impulse transmission along at least one nerve bundle without interpreting the content of the data or the nerve transmission.

Unless otherwise defined, all technical and/or scientific terms used herein have the same meaning as commonly understood by one of ordinary skill in the art to which the disclosure pertains. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

Before explaining at least one embodiment of the disclosure in detail, it is to be understood that the disclosure is not necessarily limited in its application to the details of construction and the arrangement of the components and/or methods set forth in the following description and/or the examples. The disclosure is capable of other embodiments or of being practiced or carried out in various ways.

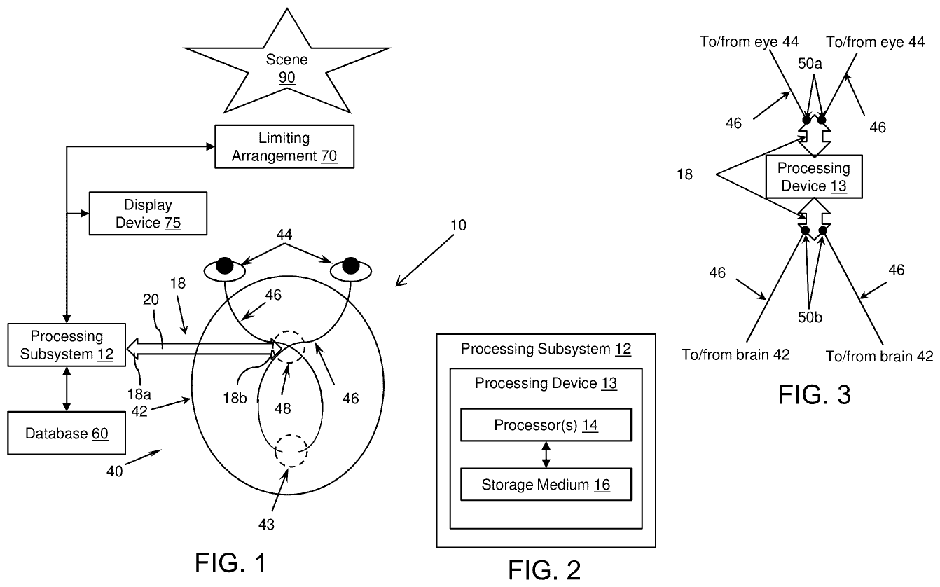

Referring now to drawings, FIG. 1 is a schematic representation of a system, generally designated 10, according to an embodiment of the present disclosure. Generally speaking, the system 10 includes a storage medium (implemented in this embodiment as a database 60) and a processing subsystem 12 that is communicatively coupled to the database 60. The processing subsystem 12 is further communicatively coupled to at least one nerve of a nerve bundle 46 of a subject (“user”) 40, which may be a human subject or a non-human animal subject. The nerve bundle 46 serves as a pathway between the eyes 44 of the user 40 and a visual processing region 43 of the brain 42 of the user 40. Thus, the processing subsystem 12 is also communicatively coupled to the visual processing region 43 of the brain 42 of the subject 40, for example via the nerve bundle 46. In an example use-case in which the system is used with human subjects, the nerve or nerve bundle includes at least one of the optic nerves. A nerve bundle is defined herein as a collection of one or more nerves that are connected to a common part or portion of the brain. For example, in human subjects, the pair of optic nerves can be considered as a nerve bundle. A single one of the optic nerves can also be considered as a nerve bundle.

In general terms, the system 10 is configured to perform various functions, including reading image nerves and reconstructing images of a scene viewed by the subject 40 with at least one of eyes 44. The details of the function and operation of the system 10, and its components, will be provided further below.

With additional reference to FIG. 2, the processing subsystem 12 includes at least one processing device 13 having at least one processor 14 and at least one storage medium 16. Each of the at least one processor 14 can be implemented as any number of computerized processors, including, but not limited to, microprocessors, microcontrollers, application-specific integrated circuits (ASICs), field programmable gate arrays (FPGAs), digital signal processors (DSPs), field-programmable logic arrays (FPLAs), and the like. In microprocessor implementations, the microprocessors can be, for example, conventional processors, such as those used in servers, computers, and other computerized devices. For example, the microprocessors may include x86 Processors from AMD and Intel, Xeon® and Pentium® processors from Intel, as well as any combinations thereof. Implementation of the at least one processor as quantum computer processors is also contemplated herein. The aforementioned computerized processors include, or may be in electronic communication with computer readable media, which stores program code or instruction sets that, when executed by the computerized processor, cause the computerized processor to perform actions. Types of computer readable media include, but are not limited to, electronic, optical, magnetic, or other storage or transmission devices capable of providing a computerized processor with computer readable instructions. It is noted that above-mentioned implementations of the at least one processor represent a non-exhaustive list of example implementations. It should be apparent to those of ordinary skill in the art that other implementations of the processing device are contemplated herein, and that processing technologies not described herein or not yet fully developed, such as biological processors or organic semiconductors in the field of biological computing technologies, may be suitable for implementing any of the processing devices discussed herein.

The storage medium 16 can be implemented in various ways, including, for example, one or more volatile or non-volatile memory, a flash memory, a read-only memory, a random-access memory, and the like, or any combination thereof. In certain embodiments, the storage medium can include one or more components for storing and maintaining hashing and mapping function functions, and at least one component configured to store machine executable instructions that can be executed by the at least one processor.

The processing subsystem 12 may be embodied as a local processing device(s), a remote processing device(s), or any combination thereof. For example, with additional reference to FIG. 5, the processing subsystem 12 may include one or more local processing device 13 and/or one or more remote processing device embodied on a remote server system 34 linked to an interface (to be described below) via one or more communication networks 36. In such embodiments, an external storage medium 32 may be linked (e.g., electronically connected) to the processing device 13. The external storage medium 32 can be used to store and provide to the processing device 13 (and hence the processing subsystem 12) with various types of data, for example, image data, hash values, signal values, etc. In certain embodiments, the database 60 may be hosted or stored on the storage medium 32. In other embodiments, the database 60 may be hosted or stored on the remote server system 34. In yet other embodiments, the database 60 may be hosted or stored on the local storage medium 16.

The processing subsystem 12 can be communicatively coupled to each nerve of a nerve bundle, or connected to the nerve bundle as a whole. In one example embodiment, the processing subsystem 12 is communicatively coupled to the optic nerve (or nerves or nerve bundle), for example in subjects having optic nerves. In other embodiments, for example in subjects lacking optic nerves, the processing subsystem 12 can be communicatively coupled to any nerve or transmission medium that is used for image transfer.

The communicative coupling can be an external coupling or an internal (or partially internal) coupling (i.e., external to the subject or internal to the subject), for example using an interface between the processing subsystem and the nerve(s) and/or brain. The external or internal coupling provides reading of one or more portions of one or more nerves of a nerve bundle (i.e., the reading can be made from one or more points of one or more nerve or one or more nerve bundle). For example, as an external coupling, an optical magnetic field sensor arrangement or a non-contact modulation arrangement employing, for example, optic, magnetic, or ultrasound techniques, can be employed to measure (“collect”, “pick up”) nerve impulses, for example as electrical signals. As another example of a coupling that is external to the subject, an electrode or electrode array can be deployed external to the subject to measure signals representative of nerve impulses. As an example of an internal or partially internal coupling, the interface and/or one or more components of the processing subsystem can be implanted in the user, for example in direct connection with the nerves, in the blood vessels (as employed, for example, by Synchron of Brooklyn, NY, USA), or using any other suitable technique. The following paragraphs provide additional discussion of examples of the communicative coupling of the processing subsystem to the nerve/nerve bundle.

In certain embodiments, the communicative coupling of the processing subsystem to the nerve or nerve bundle is effectuated by a machine-subject interfacing arrangement (referred to hereinafter interchangeably as “interface”) 18 that places the processing subsystem 12 (including at least one processing device 13) in communication with the nerve/nerve bundle. In certain embodiments, the interface 18 can include first and second interfacing portions 18a and 18b. The first interfacing portion 18a can be connected to the processing subsystem 12 and the second interfacing portion 18b can be connected or coupled to the nerve/nerve bundle. The two interface portions 18a, 18b can be interconnected via a linking portion 20 which in certain embodiments can provide a wired connection between the two interface portions, and in other embodiments can provide a wireless connection between the two interface portions.

Various deployment configurations for achieving communicative coupling of the processing subsystem 12 to the nerve/nerve bundle are contemplated herein, and several of these deployment configurations will be described in further detail below. The deployment configurations may require some type of surgical implantation, which can employ invasive or semi-invasive techniques. For example, invasive techniques can include implantation by surgically accessing the subject's nerve (e.g., optic nerve) through the subject's skull (i.e., surgically opening the skull). Surgeries performed on the human brain, in particular the visual cortex and the optic nerve, have become common over the years, and it is asserted that a trained human surgeon and/or a robotic surgeon (such as used by the Neuralink Corporation of San Francisco, USA) can perform the necessary implantation. In human subjects, semi-invasive techniques can include, for example, implantation by accessing the optic nerves or the optic chiasm through the nasal passageway via the sphenoid sinus. Before describing several deployment configurations, it is noted that the deployment configurations described herein are exemplary only and represent only a non-exhaustive subset of possible deployment options for the processing subsystem. Other deployment options may be possible, as will be apparent to those of skill in the art.

In one example deployment configuration according to certain non-limiting embodiments, the processing subsystem 12 communicates with the nerve(s)/nerve bundle by tapping the nerve(s)/nerve bundle via the interface 18. In such a deployment configuration, the second interfacing portion 18b can be surgically implanted at or on a segment (section, portion) of the nerve(s)/nerve bundle, which in certain non-limiting implementations can be effectuated by first surgically cutting the nerve(s) to produce cut ends of the nerve(s), and then connecting the second interfacing portion 18b to the cut ends. In such a deployment configuration, the processing subsystem preferably remains external to the brain of the subject. When the processing subsystem is external to the subject, the second interfacing portion 18b is surgically implanted at or on the nerve(s) together with either the entirety of the linking portion 20, or a segment of the linking portion that connects to the second interfacing portion. If only the segment of the linking portion 20 that connects to the second interfacing portion 18b is surgically implanted, the remaining segment of the linking portion, which connects to the first interfacing portion 18a, is external to the subject 40. In certain non-limiting deployment configurations in human subjects, the segment of the nerve(s) at or on which the second interfacing portion is surgically implanted is the optic chiasm 48, which is the portion of the brain at which the optic nerves cross each other.

In another example deployment configuration, the processing subsystem 12 is deployed external to the subject, and the second interfacing portion 18b is surgically implanted at or on the nerve(s) together with either the entirety of the linking portion 20 or a segment of the linking portion that connects to the second interfacing portion 18b. If only the segment of the linking portion 20 that connects to the second interfacing portion is surgically implanted, the remaining segment of the linking portion, which connects to the first interfacing portion 18a, is external to the subject.

In yet another example deployment configuration according to certain non-limiting embodiments, a local processing device 13 of the processing subsystem 12, together with the entirety of the interface 18, can be implanted at or on the nerve(s) 46. In another example deployment configuration according to non-limiting embodiments, the local processing device is implanted at or on a segment of the nerve(s) 46. FIG. 3 schematically illustrates such a deployment configuration. Here, the implantation can be effectuated, for example, by first cutting the nerve(s) to produce first and second cut ends 50a, 50b of the nerve(s) 46, and then deploying the local processing device 13 at the sight of the cut and connecting the two cut ends of the nerve(s) to the local processing device 13 via the interface 18. In certain non-limiting deployment configurations in human subjects, the segment of the nerve(s) at or on which the local processing device 13 is implanted can be, but is not necessarily, the optic chiasm, whereby the optic nerves 46 are surgically cut (to produce the two cut ends 50a, 50b) at the optic chiasm 48. It is noted that in embodiments in which the local processing device 13 or the interface 18 is surgically implanted at the optic nerve 46, consideration be taken to ensure that the cut ends 50a, 50b to which the local processing device 13 is interfaced, correspond to the same nerve.

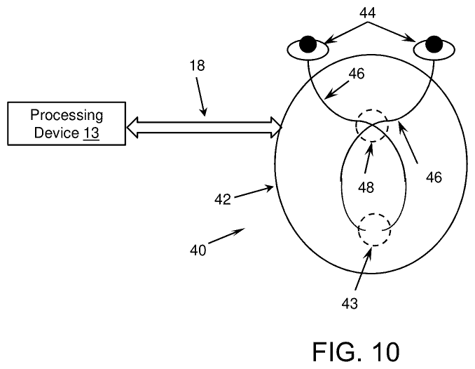

Non-invasive deployment configurations are also contemplated herein, for example as illustrated in FIG. 10. For example, the interface 18 can be provided by way of an optical magnetic field sensor arrangement or a non-contact modulation arrangement employing, for example, optic, magnetic, or ultrasound techniques. In such configurations, the interface (and its related components) as well the local processing device 13 (and all subcomponents of the processing subsystem 12) are completely external to the brain 42. The external interface 18 picks up brain signals at the nerve(s) via non-contact or non-invasive contact means, and provides those picked up brain signals to the local processing device. Other non-invasive interfaces 18 can include, for example, EEG, MEG, fMRI, and fNIRS, and the like.

It is noted herein that the processing subsystem can employ various techniques for obtaining nerve impulses (and their representative signals) from the nerve(s) of the subject. Such techniques may typically rely on employing microdevices, such as microelectrodes or microtransducers, for measuring (receiving) nerve impulses and producing signals in response thereto. Various entities have conducted research, development, and experimentation on connection and interfacing of computer processing devices to the brain, tissue, and nerves via implantation or other invasive or semi-invasive means. One example of such research can be found in a publication by the University of Luxembourg in 2019 entitled “CONNECT-Developing nervous system-on-a-chip” (available at https://wwwfr.uni.lu/lcsb/research/developmental_and_cellular_biology/news/connect_develo ping_nervous_system_on_a_chip), which describes culturing individual nervous system components and connecting the components in a microfluid chip (integrated circuit).

Examples of research and experimentation in the field of brain-machine interfacing is described in an article published in Procedia Computer Science in 2011, entitled “Brain-Chip Interfaces: The Present and The Future” by Stefano Vassanelli at the NeuroChip Laboratory of the University of Padova in Italy. In one example, computerized processing devices are interfaced to neurons with metal microelectrodes or oxide-insulated electrical microtransducers (e.g., electrolyte-oxide semiconductor field-effect transistors (EOSFETs) or Electrolyte-Oxide-Semiconductor-Capacitors (EOSCs)) to record (i.e., measure) or stimulate neuron electrical activity. In another example, large-scale high-resolution recordings (i.e., measurements) from individual neurons are obtained using a processing device that either employs or is coupled to a microchip featuring a large Multi-Transistor-Array (MTA). In yet a further example, a microchip featuring a large MTA is used to interface with the cells in vitro by deploying the MTA in contact with brain tissue, where the signals corresponding to nerve impulses are, in one example, in the form of local-field-potentials (LFPs).

An example of a brain-machine interface device is the Neuralink device, developed by Neuralink Corporation of San Francisco, USA. The Neuralink device includes an ASIC that digitizes information obtained from neurons via microelectrodes.

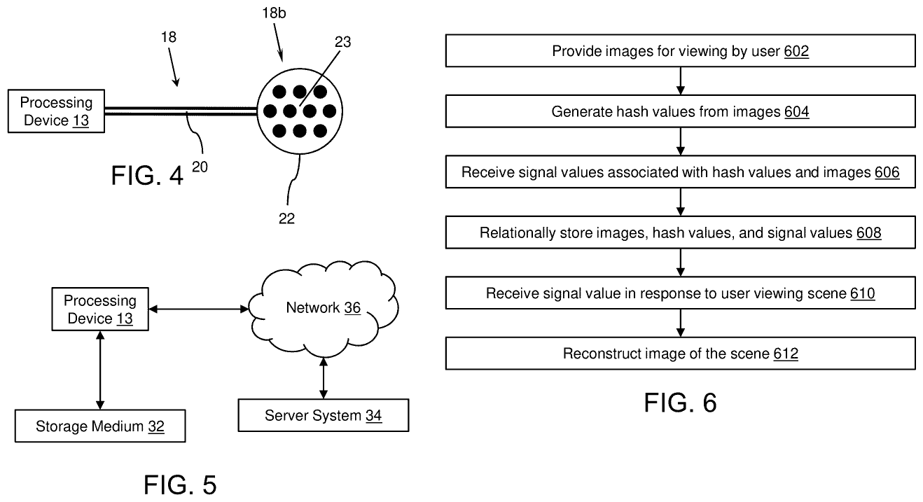

Bearing the above in mind, and with additional reference to FIG. 4, in certain embodiments the machine-brain interface can include an electrode array 22, having a plurality of electrodes 23, that is deployed at or on the nerve(s) (e.g., at or on the optic chiasm) or externally to the subject to collect readings from one or more points of one or more nerve or one or more nerve bundle. The electrodes 23 are preferably microelectrodes, such as EOSFETs or EOSCs. The electrode array 22 is operative to measure nerve impulses transmitted by or through the nerve(s)/nerve bundle and produce (in response to the measurements) signals associated with (and representative of) the nerve impulses, and provide those signals to the processing subsystem in order to enable the processing device to collect the nerve impulses and process the signals.

In certain embodiments two interfaces may be used, for example in situations in which a large segment of the nerve(s)/nerve bundle of interest is non-functioning or malfunctioning, or is missing, e.g., has been cut or removed, for example as a result of a surgical procedure for treatment of a disease or for example, removal of cancerous tumors in the vicinity of the optic nerves may result in the removal of the majority of the optic nerves, which can lead to loss of vision. For example, in a scenario in which a segment of the nerve bundle connecting between the brain and the eyes is missing, one of the interfaces can be connected to one portion of the nerve bundle (e.g., the portion connected to the eyes), and the other interface can be connected to another portion of the nerve bundle (e.g., the portion connected to the brain).

Further details of communicative couplings between a processing subsystem and a subject's brain are provided in the following commonly owned patents: U.S. Pat. No. 11,395,620, 11,733,776, 11,712,191, 11,660,040, and 12,171,567, all of which are incorporated by reference in their entireties herein.

According to certain embodiments of the present disclosure, image nerve reading and scene image reconstruction is provided by the system 10. Methods for reading the nerve/nerve bundle have been described above. Scene image reconstruction will now be discussed. In one embodiment, the database 60 may be configured to store every possible unique image (permutation of image pixels). Each possible image may be displayed to the user 40 so that the user views the image with at least one of the eyes 44. In response to viewing each image, nerve impulses are transmitted along at least one nerve bundle 46, and signal value corresponding to the nerve impulse transmission may be recorded by the processing subsystem 12. In this way, each image, when viewed by the user 40, has a corresponding signal value. The database 60 may then store (e.g., relationally) each possible image with its corresponding signal value. Subsequently, when the user views a scene, the signal value that corresponds to the nerve impulse transmission responsive to viewing the scene may be recorded by the processing subsystem 12. The processing subsystem 12 may then look-up the recorded value in the database 60, and retrieve the image corresponding to the recorded value. This retrieved image is a faithful representation of the scene viewed by the user 40.

It will be appreciated that in certain embodiments, the aforementioned signal values may be measured by the processing subsystem 12 itself. In other embodiments, the signal values may be measured by one or more components of the interfacing arrangement 18, as described above. The signals being measured may be in various forms, including, for example, electrical signals (where the measured values may be one or more of current, voltage, and the like), magnetic signals, voxel intensity signals, and others, as is known in the art. The particular form of the signals may depend on various factors, including for example the type of interfacing arrangement 18.

It should immediately be apparent that such an embodiment, while ideal in the sense of its accuracy of providing faithful representations, may not be practical due to the extraordinarily large number of possible images. For example, for an M by N image having M*N pixels with 24-bit color depth, the number of possible unique images is 2^{(M*N*24)}. To put that in perspective, for a 3 by 3 (nine-pixel) image, that would result in approximately 1.05*1065 total possible images. Presenting such a large number of images to the user may not be feasible, not to mention that storing that many images in any database may present technological challenges. To overcome these issues, the system 10 according to certain embodiments of the disclosure employs more sensible approaches to efficiently present, store, and reconstruct images. These approaches dramatically cut down the number of images to a reasonable sample size which still enable the system 10 to reconstruct images that are faithful representations of the scene viewed by the user 40.

In one approach according to non-limiting embodiments, database 60 build-up and subsequent image reconstruction is performed by employing hash functions. More particularly, the processing system 10 builds-up the database 60 by applying a hash function to a sample set of images which are also provided to the user for viewing, and image reconstruction is performed based at least in part on hash values in the built-up database. In further detail, and with reference to the flow diagram illustrated in FIG. 6, a plurality (sample set) of images are provided to the user 40 in sequence for sequential viewing with at least one of the eyes 44 (step 602). The processing subsystem 12 may generate a plurality of hash values associated with the plurality of images by applying a hash function to each image of the plurality of images (step 604). The processing subsystem 12 may also receive a plurality of signal values associated with the plurality of hash values and the plurality of images (step 606). Each signal value corresponds to a nerve impulse transmission along the nerve bundle(s) 46 in response to the user 40 viewing a respective one of the images with the eye(s) 44. The processing subsystem 12 may then instruct the database 60 to relationally store the plurality of images, the plurality of hash values, and the plurality of signal values (step 608). The database 60 thus maintains, in a relational manner, a plurality of images, a plurality of hash values associated with the plurality of images, and a plurality of signal values associated with the plurality of hash values and the plurality of images. Subsequently (after the database is built-up), when the user views a scene, the signal value that corresponds to the nerve impulse transmission responsive to viewing the scene may be received (recorded) by the processing subsystem 12 (step 610). The processing subsystem 12 may then reconstruct an image of the scene, whereby the reconstructed image is a faithful representation of the scene as viewed by the user 40 (step 612). The reconstruction is based on: i) at least one of the images stored in the database 60, and ii) a relationship between a hash value in the database associated with the received signal value and the hash value associated with each image of the at least one image.

It is noted that for execution of step 602 (presentation of images), the images may be presented in a way such that the images do not occupy the user's peripheral field of view. The user's peripheral view may be “open” to view the real world, or other images, such as virtual reality images or other types of images, which may be displayed to the user's 40 peripheral field of view via display device.

In certain embodiments, the images stored in the database 60 are stored in their original form, whereas in other embodiments, one or more of the images can be stored in a compressed format. In certain embodiments, a difference image, that is the difference between pairs of images, can be stored. The difference image can be the difference between consecutive images in the sequence of presented images, for example the difference between the last presented image and the next-to-last presented image. As another example, the difference image can be the difference each presented image and a baseline image (e.g., the first presented image). It is noted that the difference image refers to the difference in pixel values of corresponding pixels in the pair of images. The difference image can be stored as the actual difference or the difference can be in certain cases a formula. Furthermore, in certain cases a pattern may be established for changes in pixel values. If such a pattern is established for the pixel changes, and then pixels change, then only the established pattern need be stored. If the hash that is used has some pattern, such as a linear pattern, then only the pattern need be stored. If the signal that is used has some pattern, such as a linear pattern, then only the pattern need be stored. The processing subsystem 12 may execute one or more pattern recognition techniques to identify such pattern for changes in pixel values. The pattern recognition techniques may include, for example, machine learning models, artificial intelligence engines, or other suitable techniques.

In certain embodiments, additional data associated with the image may also be relationally stored in the database 60. The additional data may include, pertinent data, metadata, or other data, for example data or information descriptive of what the image represents.

In embodiments in which difference images are stored in the database 60, the baseline image upon which the image difference is based can also be retrieved from the database 60, and the original image can be restored by applying an inversion to the difference image.

It is noted that in certain cases (albeit rare cases), two (or more) different images may generate the same hash value. In such cases, a single hash value may point to two (or more) images in the database 60. This problem may be avoided at the database build-up stage by removing duplicate entries. For example, each new addition to the database can be compared to the previous images (database entries) to find any duplicates. Duplicates can be found by comparing a new image to all previous images. The comparison can be performed using the baseline method discussed above. The new image can be changed using the baseline differences from the baseline backwards, i.e., changing the new image backwards into the baseline. If the baseline image is not equal to the new image, the processing subsystem 12 may refrain from entering the new image and its corresponding hash value into the database 60, and/or may issue an alert indicating that the database has a duplicate hash value entry. In certain embodiments, a non-valid image (i.e., an image having a duplicate hash value) can be replaced with the image having the same has value, or can be discarded (for the real time operation), or simply ignored and allowed to let the brain handle the duplication.

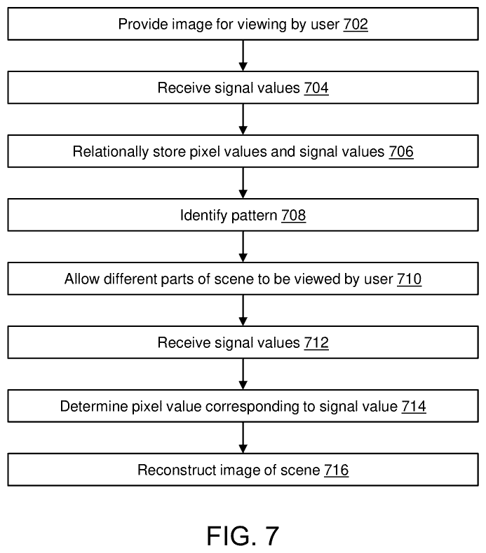

In another set of non-limiting embodiments, database 60 build-up and subsequent image reconstruction is performed using a different approach, which will now be described with reference to FIG. 7. Here, an image is presented (provided) to the user 40 at (i.e., over) a first sequence of instances (step 702). The first sequence of instances is composed of a series of temporal (time) instances, which may be equally spaced or unequally spaced. The image that is presented to the user 40 includes a plurality of pixels, where each pixel assumes a pixel value. The image is presented to the user 40 in a unique way such that: i) all but a subset of the pixels are held at a constant pixel value over the first sequence of instances, and ii) at each subsequent instance in the first sequence of instances the pixel value of the pixels in the subset of pixels is changed relative to the pixel value at a previous instance in the first sequence of instances such that there is a plurality of pixel values corresponding to the first sequence of instances. The processing subsystem 12 may then receive, for each instance of the first sequence of instances, a first signal value (step 704). Each received first signal value corresponds to a nerve impulse transmission along the nerve bundle(s) 46 in response to the user 40 viewing the pixel(s) in the subset, such that there is a plurality of first signal values corresponding to the plurality of pixel values. The processing subsystem 12 may then instruct the database 60 to store the plurality of pixel values and the associated plurality of first signal values (step 706). The storing is such that each pixel value and its associated first signal value are linked (relationally stored). Thus, the database 60 maintains, in a relational manner, a plurality of pixel values and a plurality of first signal values, where the plurality of pixel values are derived from the subset of pixels (i.e., the pixel(s) in the subset) of the image presented to the user 40 over the first sequence of instances. The processing subsystem 12 may additionally process the relationally stored pixel values and first signal values to identify a pattern between how pixel values change and how the signal values change (step 708). The pattern may also be stored in the database 60.

After the database 60 is built-up, the processing subsystem 12 may reconstruct an image of a scene 90 (different from the presented image) viewed by the user 40, using the built-up database 60 and a limiting arrangement 70 that is deployed relative to the user 40 and the scene 90 and within the field of view of the user 40. First, at each instance of a second sequence of instances (taken over the period during which the user 40 views the scene 90), the limiting arrangement 70 allows a different part of the scene 90 within the user's field of view to be viewed by the eye(s) 44 (step 710). The second sequence of instances is composed of a series of temporal (time) instances, which may be equally spaced or unequally spaced. Then, the processing subsystem 12 receives, for each instance of the second sequence of instances, a second signal value that corresponds to a nerve impulse transmission along the nerve bundle(s) 46 in response to the user 40 viewing the part of the scene 90 (step 712). Then, the processing subsystem 12 determines, for each second signal value, a corresponding pixel value based on the plurality of pixel values and the plurality of first signal values that are relationally stored in the database 60 (step 714). Finally, the processing subsystem 12 may reconstruct an image of the scene 90 from the determined corresponding pixel value for each second signal value (step 716), whereby the reconstructed image is representative (a faithful representation) of what the subject sees when viewing the scene 90 with the eye(s) 44.

It will be appreciated that steps 702 through 708 correspond to steps of a sub-process of building up the database 60, and steps 710 through 716 correspond to steps of a sub-process for image reconstruction. Depending on the image pixel read-out, the image reconstruction sub-process may be akin to image display in sequential display technology, whereby pixels are rapidly illuminated sequentially pixel by pixel and line by line until the entire image is displayed, or non-sequential display technology.

The various steps of the process of FIG. 7 will now be described in further detail. Beginning at step 702, this step is performed by first selecting the pixels in the subset, which may be selected by the user 40 via the processing subsystem 12 or may be a pre-configured selection by the processing subsystem 12. In certain embodiments, the subset of pixels may consist of only a single pixel, whose position may be anywhere in the image but may preferably be at an edge or central part of the image. In other embodiments, the subset may consist of a small group of adjacent pixels (typically up to three or four pixels), the position of which may be anywhere in the image but may preferably be at an edge or central part of the image. The pixel value of the pixels not in the subset (i.e., outside of the subset) is held constant, preferably so that these constant pixel values present as black or white. For the pixel(s) in the subset, the pixel value of that pixel(s) is changed at each instance in the first sequence of instances. The change in pixel value is preferably such that over course of the first sequence of instances, the pixel value assumes all possible pixel values (e.g., all possible bit patterns or possible corresponding decimal values). In one example, the pixel value is changed by changing one or more bits for each instance in the binary string representing the pixel value such that all possible bit patterns are cycled through. For example, for an 8-bit pixel value, one or more bits are changed for each instance so that all 256 bit patterns are cycled through (where each bit pattern corresponds to a decimal pixel value) over the course of the first sequence of instances. In certain embodiments, the pixel value of the subset of pixels may be changed sequentially by cycling through the bit patterns in order from their decimal zero equivalent up through their decimal 2^{N}−1 equivalent (where N is the number of bits). Thus, for example, decimal pixel values of 0, 1, 2, . . . K may be cycled through (where K=2^{N}−1). In other embodiments, the pixel value of the subset of pixels may be changed in another deterministic order, but preferably so that decimal values are not repeated and that all decimal values are ultimately represented. Regardless of how the pixel values in the subset of pixels are changed, the aforementioned change in pixel values is according to some deterministic pattern or sequence.

At step 704, for each pixel value (e.g., bit pattern), the signal value (corresponding to nerve impulse transmission along the nerve bundle(s) 46 in response to the user 40 viewing the subset of pixels at that pixel value) is measured and received by the processing subsystem 12. Thus, for example, for a decimal pixel value of m, a corresponding signal value Sₘ is measured and received. As a result, the processing subsystem 12 receives a signal value for each pixel value. In the non-limiting example case of cycling through all bit patterns of an N-bit pixel value, this yields 2^{N} signal values (e.g., 256 signal values for an 8-bit pixel value). For example, signal values S₀, S₁, S₂, . . . S_{K} are measured and received for the corresponding pixel values of 0, 1, 2, . . . K.

At step 706, the processing subsystem 12 sends the pixels values and the signal values to the database 60, where signal values and pixel values are relationally stored. This means that each one of the pixel values is linked in the database 60 to a respective one of the signal values, and vice versa. Thus, for example, if the processing subsystem 12 receives a signal value of Sₘ when the decimal pixel value m is presented, the pixel value m and the signal value Sₘ are relationally stored (linked) in the database 60.

At step 708, the processing subsystem 12 may execute one or more pattern recognition techniques to identify a pattern between how pixel values change and how the signal values change. The pattern recognition techniques may include, for example, machine learning models, artificial intelligence engines, or other suitable techniques. In certain embodiments, the identified pattern can be used to reduce the size of the database 60. For example, using the identified pattern, the processing subsystem 12 may delete some of the data from the database 60, or refrain from instructing the database 60 to store some of the data.

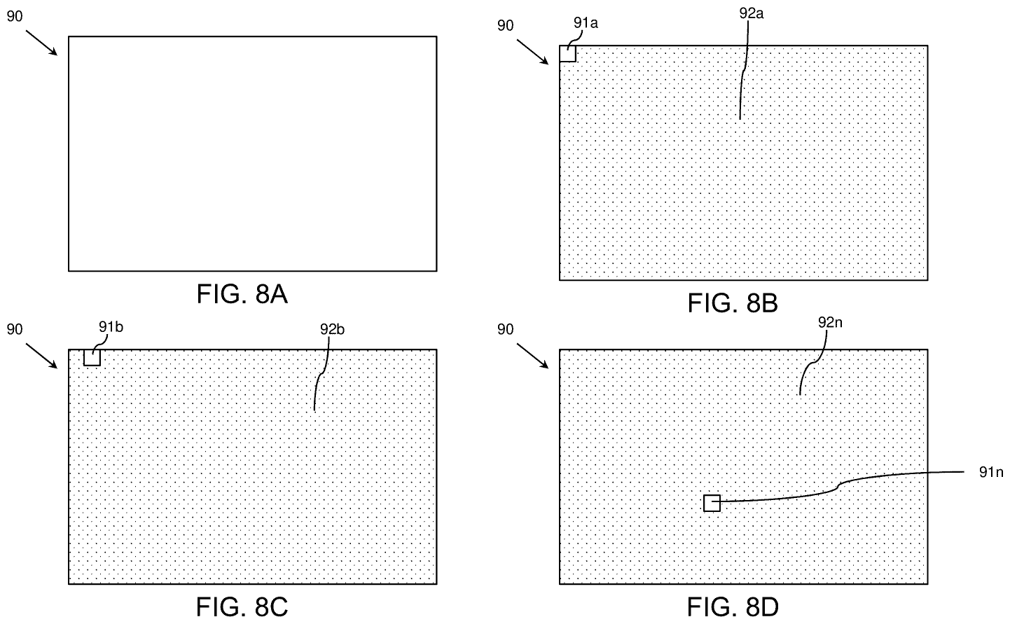

At step 710, the limiting arrangement 70 allows a different part of the scene 90 within the user's field of view to be viewed by the eye(s) 44 at each instance of the second sequence of temporal (time) instances. This can most easily be described with additional reference to FIGS. 8A-8D , which represent the view of the scene 90 from the perspective of the user 40.

FIG. 8A is representative of the central field of view of a scene 90 (excluding periphery), unobstructed by the limiting arrangement 70. It is noted that although the field of view of a healthy adult human is oval or elliptical in shape, typically approximately 60° horizontal (about ±30° from center) and approximately 40° vertical (about ±20° from center), for the sake of ease of presentation the field of view is represented herein as rectangular in shape.

At an initial (first) instance of the second sequence of instances, the limiting arrangement 70 allows only light from a first part 91a of the scene 90 to reach the user's eye(s) 44, by blocking (preventing) light from all other parts 92a of the scene 90 from reaching the user's eye(s) 44. Thus, the entire scene may appear dark to the user 40, save for the first part 91a, as shown in FIG. 8B (where the “dark” part is the dotted region designated 92a). Then, at the next (second) instance of the second sequence of instances, the limiting arrangement 70 allows only light from a second part 91b of the scene 90 to reach the user's eye(s) 44, by blocking (preventing) light from all other parts 92b of the scene 90 from reaching the user's eye(s) 44. This second part 91b is different from the first part 91a, and may be adjacent to the first part 91a. Thus, the entire scene may appear dark to the user 40, save for the second part 91b, as show in FIG. 8C (where the “dark” part is the dotted region designated 92a). This process may continue, with the limiting arrangement 70 allowing (preferably sequentially) light from different parts of the scene to reach the user's eye(s) 44 over the course of the second sequence of instances, until eventually light from all of the individual parts of the scene have reached the user's eye(s) 44. FIG. 8D shows the scene at the n^{th} instance, where only light from the n^{th} part 91n of the scene 90 reaches the eye(s) 44 of the user 40, and the remaining parts 92n of the scene 90 appear dark (dotted in the figure) to the user 40.

It is noted that the limiting arrangement 70 may, in addition to blocking (preventing) the light from particular parts of the scene 90 from reaching the eye(s) 44, provide light masking, so that the regions of the scene (from which light is blocked) appear to the user as black (i.e., “dark” as discussed above) or as white. Thus, the dotted regions illustrated in FIGS. 8B-8D may represent apparent white.

At each stage, the allowed parts of the scene are small points in the scene, typically on the order of one a tenth or a thousandth of a percent of the area of the rectangle that represents the user's two-dimensional field of view (effectively equivalent to the size of a pixel or a small group of pixels). In certain preferred embodiments, the allowed part of the scene at the current instance is adjacent to the allowed part of the scene at the previous instance and the next instance (to sequentially allow light from different parts of the scene to reach the user's eye(s) 44 over the course of the second sequence of instances). In other embodiments, the allowed part of the scene at the current instance is not adjacent to the allowed part of the scene at the previous instance and/or the next instance. Furthermore, the limiting arrangement 70 allows light from the different parts of the scene in rapid sequence, preferably at a refresh rate of a fraction of a millisecond (or smaller) so that the light blocking is not discernible to the user 40 and has little to no impact on the viewing experience of the user 40.

The limiting arrangement 70 can be implemented in various ways, and may be removably mounted to the user 40, for example integrated into a user-wearable head-mounted display or type of user-mounted arrangement. In one non-limiting embodiment, the limiting arrangement 70 is implemented as a partially transparent display device that is deployed between the eye(s) 44 and the scene 90. For example, the partially transparent display device may be integrated in a head-mounted display, such as an eyeglass form factor, so as to be deployable between the eye(s) 44 and the scene 90. The partially transparent display device, when not displaying any image data, allows the user to clearly view the scene through the display device. In contrast, when the pixels of the display device are activated (illuminated), those active pixels project light (corresponding to an image) that reaches the user's eye(s) 44 which effectively blocks the light behind that pixel from reaching the eye(s) 44. As another example according to another non-limiting embodiment, the limiting arrangement 70 may be implemented as a holographic display device, which may produce illumination corresponding to an image that effectively blocks light from parts of the scene 90 from reaching the user's eye(s) 44. The holographic display device may also be integrated in a head-mounted display, for example eyeglass form factor. Other example implementations of the limiting arrangement 70 are also contemplated, for example mechanical light blocking configurations such as filter wheels, and optical blocking configurations such as polarization filters.

As mentioned, during execution of step 710 the limiting arrangement 70 allows a different part of the scene 90 within the user's field of view to be viewed by the eye(s) 44 at each instance of the second sequence of temporal (time) instances. This implies that the user's peripheral field of view may be completely or at least partially unobstructed by the limiting arrangement 70. It is noted that during execution of step 710, the user's peripheral view may be “open” to view the real world, or other images, such as virtual reality images or other types of images, which may be displayed to the user's 40 peripheral field of view via display device.

At step 712, for each instance of the second sequence of instances, the signal value that corresponds to a nerve impulse transmission along the nerve bundle(s) 46 in response to the user 40 viewing the part of the scene 90 is measured and received by the processing subsystem 12. Thus, for example, at the n^{th} instance (where only light from the n^{th} part of the scene 90 reaches the eye(s) 44 of the user 40) a corresponding signal value of Rₙ is measured and received. As a result, the processing subsystem 12 receives a signal value for each part of the scene. Thus, for example, if the scene is sub-divided into M parts that correspond to M instances, the processing subsystem 12 will receive M corresponding signal values (i.e., R₁, R₂, . . . R_{M}).

At step 714, the processing subsystem 12 determines, for each of the signal values R₁, R₂, . . . R_{M}, a pixel value that corresponds to the signal value. This determination is based on the plurality of pixel values (0, 1, 2, . . . K) and the plurality of first signal values (S₀, S₁, S₂, . . . S_{K}) that are relationally stored in the database 60 (at step 706), and may be further based on the pattern identified in step 708. The determination may be performed by the processing subsystem 12 in various ways. In one set of embodiments, each of the signal values R₁, R₂, . . . R_{M} can be looked-up in the database 60 to identify if there is a corresponding pixel value. If a signal value Rₙ has an exact corresponding pixel value in the database 60, the processing subsystem 12 may retrieve that value from the database 60 and be done. However, if a signal value Rₙ does not have an exact corresponding pixel value in the database 60, the processing subsystem 12 may estimate a pixel value based on the signal value Rₙ and the pixel values 0, 1, 2, . . . K and the plurality of first signal values S₀, S₁, S₂, . . . S_{K} stored in database 60. The processing subsystem 12 may utilize any suitable estimation technique to estimate the pixel value, including, for example, machine learning models (k-nearest neighbor regression, neural networks, support vector regression, etc.), spline methods (e.g. cubic splines, piece-wise polynomial fitting, etc.), database look-up with interpolation (linear, bilinear, cubic, etc.) between database entries, etc. As one particular but non-limiting example, the processing subsystem 12 may use a curve-fitting approach to calculate an approximated pixel value. For example, the processing subsystem 12 may represent the relationship between the pixel values 0, 1, 2, . . . K and the plurality of first signal values S₀, S₁, S₂, . . . S_{K} (relationally stored in database 60) as a curve (or graph). The curve may be a linear curve, piece-wise linear curve, or non-linear curve. For example, in a simple case, each (m, Sₘ) pair (i.e., pair of pixel value and signal value) from step 706 can be plotted in two-dimensional space, and a curve can be generated (which as mentioned can be a linear curve, piece-wise linear curve, or non-linear curve, i.e., smoothed curved). The processing subsystem 12 may then determine the pixel value that corresponds to signal value Rₙ by fitting signal value Rₙ to the curve. The curve-fitting can include the processing subsystem 12 performing one or more of interpolation, extrapolation, regression, and smoothing. For example, the processing subsystem 12 may generate the curve by interpolating and/or extrapolating the pixel value and signal value pairs from step 706 (and may then optionally smooth the curve). This curve generation may be performed as part of the pattern identification of step 708. The processing subsystem 12 may then extract a pixel value from the curve by identifying the pixel value that corresponds to the Rₙ on the curve.

In other embodiments, the processing subsystem 12 may, for example as part of the pattern identification step 708, derive a mathematical formula or functional relationship that characterizes the relationship between the pixel values 0, 1, 2,. K and the plurality of first signal values S₀, S₁, S₂, . . . S_{K} (relationally stored in database 60), and this formula or functional relationship can be use by the processing subsystem 12 to determine the pixel value that corresponds to signal value R₁. The processing subsystem 12 may employ various techniques for deriving the mathematical formula or functional relationship, including, for example, symbolic regression, non-linear least squares, sparse regression, etc. In addition, one or more of the estimation techniques discussed above can also be used to derive the formula or functional relationship.

Finally, at step 716, the processing subsystem 12 may reconstruct an image of the scene 90 from the determined corresponding pixel value for each of the signal values R₁, R₂, . . . R_{M}. This image reconstruction includes, for example, registering each pixel value in a pixel location corresponding to the spatial location in the scene from which light was allowed to reach the eye(s) 44 of the user 40. For example, for a given signal value Rₙ that was measured/received at the n^{th} instance (where only light from the n^{th} part of the scene 90 reached the eye(s) 44 of the user 40), the spatial location of the n^{th} part of the scene 90 is assigned a spatial location tag by the processing subsystem 12. This spatial location tag is then used by the processing subsystem 12 to indicate the pixel position for the pixel value that is determined (at step 714) to correspond to the signal value Rₙ.

It is noted that steps 702 through 706 may be repeated for different subsets of pixels. For example, steps 702 through 706 may be executed for one particular subset of pixels, and then re-executed for a different subset of pixels. After each execution of step 706, a pattern may be identified at step 708, and the identified patterns can be compared in order to refine and/or verify the patterns.

In certain embodiments, any one of the image reconstruction steps 710 through 716 may be selectively executed in response to the processing subsystem 12 receiving a control input, for example received from the user 40. In general, the control input provides a control signal that causes the relevant component (e.g., processing subsystem 12, limiting arrangement 70) to execute or refrain from executing one or more of steps 710 through 716. This enables the user to control when image reconstruction is performed. Practically, in a default setting, the limiting arrangement 70 passively allows all light from the scene to reach the user's eye(s), thereby making the user's full field of view “open” to view the real world. Then, the user 40 may provide a controlled signal input to the processing subsystem 12 to execute the image reconstruction steps 710 through 716.

In general, once an image is reconstructed (using any of the techniques described in this document), the system 10 may perform one or more actions on the image, including, for example, modifying the reconstructed image, storing the reconstructed image and/or the modified image (in local memory and/or remote memory), displaying images (e.g., the reconstructed image and/or the modified image and/or an image derived from the reconstructed image and/or modified image), etc. Such actions have been well described in the aforementioned and incorporated patent documents U.S. Pat. Nos. 11,395,620, 11,712,191, and 12,171,567.

A display device 75 may be communicatively coupled to the processing subsystem 12 in order to display the images, and the processing subsystem 12 and the display device 75 may cooperate to support the display switching techniques described in U.S. Pat. No. 12,171,567. In certain embodiments, the limiting arrangement 70 may be used as the display device, for example in embodiments where the limiting arrangement is implemented as a partially transparent display device.

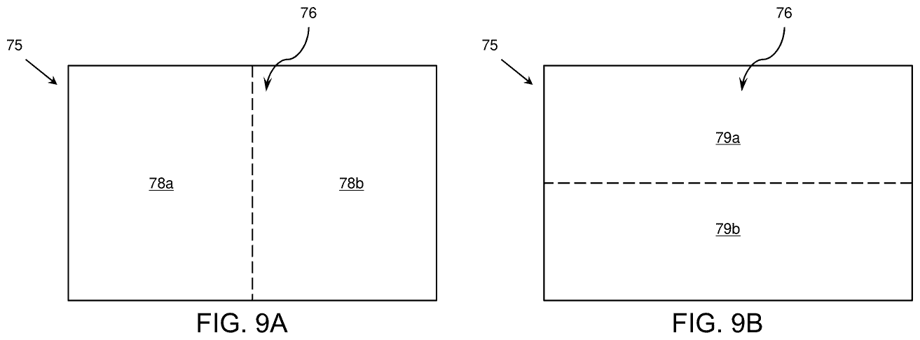

According to certain embodiments, the display area of the display device 75 may be sub-divided into multiple regions so that the image for display (e.g., reconstructed image, modified image, image derived from the reconstructed image and/or modified image) is only displayed some (but not all) of the regions. FIG. 9A illustrates a non-limiting example of a sub-division of the display area 76 of the display device 75. Here, the display area 76 is sub-divided into equal sized upper and lower regions 78a and 78b, and the image for display may be displayed on only one of the regions 78a or 78b. The other region 78b or 78a may display another image or images, for example images from the real scene viewed by the user 40 or another scene. FIG. 9B illustrates another non-limiting example sub-division in which the display area 76 is sub-divided into equal sized left and right regions 79a and 79b. It will be appreciated that the sub-divisions illustrated in FIGS. 9A and 9B are merely non-limiting examples of sub-divisions, and that the sub-divisions need not yield regions of equal size or shape, nor yield any particular number of regions. For example, embodiments are contemplated herein in which some of the regions display the image for display (e.g., reconstructed image, modified image, image derived from the reconstructed image and/or modified image), some of the regions display the real world, all of the regions display the image for display, or all of the regions display the real world. Moreover, embodiments are contemplated in which the display device 75 is sub-divided into more than two regions and parts (i.e., some or all) of the image for display (derived from the reconstructed image) are displayed on one or more of the regions. Embodiments are also contemplated in which the regional sub-divisions and/or the images displayed on the regions changes over time. For example, in certain embodiments the display may be actuated so that a region of the display area that is initially configured to display the real world can be re-configured to display a reconstructed image, a modified image, or an image derived from the reconstructed image and/or modified image. For example, the re-configuration for display of a reconstructed image of the real world scene can be used to check if the reconstructed image is shifted or positioned in such a way that it can affect the reconstructed image or the user's viewing experience.

It is noted that many nerves and nerve bundles include nerves that are utilized for additional functions besides simply transferring image. For example, the optic nerves are also utilized for eye control (command) functions, such as eye movement and pupil opening. Therefore, certain nerve impulses may be inherently tied to eye control (commands), and therefore the signal measurements (corresponding to such nerve impulses) should preferably be removed to offset or calibrate the nerve impulse measurements. The measurements pertaining to non-imaging (e.g., eye control) can be obtained by taking one or more measurements along several portions of the nerves. Nerve impulses pertaining to non-imaging (commands) can, for example, be identified by the direction of their movement along the transmission route, for example opposite to the direction of the images. The direction can be seen by measurements of their direction of propagation and as a comparatively short spike or other type of pattern, which can include continuous and/or constant signal values, modulated signals, and the like and any combinations thereof. Any nerve transmission that is not an image can be identified, for example, by the fact that the transmission is not a continuous stream like the images of frame by frame but rather as short bursts or for example by not following the image pattern.

Throughout the present disclosure, reference has been made to measuring and/or receiving signals and signal values that correspond to transmission of nerve impulses along nerve bundle(s) in response to the user viewing a scene (e.g., a real scene, an image, a virtual reality (VR) image, or other visual stimuli). It is understood that a “signal value” as used herein, is broadly defined and may represent a single numerical value, or a set or collection of numerical values, each configured to encode one or more parameters associated with nerve impulse transmission. This encompasses scenarios where a single signal value encodes multiple types of information, or where multiple discrete signal values each encode a distinct parameter corresponding to a single nerve impulse transmission, consistent with the complex nature of visual information transmission along neural pathways. For example, as described elsewhere herein, various estimation techniques may be applied to measured signal values. In instances where a signal value comprises a set or collection of numerical values, such estimation techniques (e.g., curve fitting) may be applied to each individual numerical value within the set or collection, or to the set or collection as a whole (e.g., by performing multi-dimensional estimation, such as multi-dimensional curve fitting). By way of non-limiting example, as is known, the human nervous system transmits color information not through raw base color (RGB) values, but rather as encoded nerve impulses along the optic nerve based on opponent processing. This transmission inherently involves a multitude of parameters, including, without limitation, the number of activated nerves within a nerve bundle, the transmission rate of the nerve impulses (e.g., the spike rate and/or frequency), neural pattern activation, and other analogous physiological or neurological parameters. Consequently, the measured “signal value” or values corresponding to nerve impulse transmission may encode any one or more of these or other described parameters. Accordingly, the term “signal value” is not limited to an absolute single numerical value, but rather explicitly encompasses any data representation that conveys information and parameters encoded in nerve impulse transmission.

It is noted that in human subjects, the visual processing region of the brain is commonly referred to as the visual cortex. The visual processing region is also commonly referred to as the visual cortex in many other non-human types of animals, including, for example, canine species, feline species, non-human primate species, and rodent species. In human subjects and many other vertebrates, the visual cortex is a part of the temporal lobe that processes visual information. In animal species that do not have a cerebral cortex or visual cortex, for example reptile species, bird species, non-mammal marine/aquatic species), the term “visual processing region” refers to the equivalent portion or portions of the brain that performs visual processing. Thus, although the embodiments of the present disclosure may be of particular value when applied within the context of human vision and implemented for use with human subjects, embodiments of the present disclosure may be equally applicable for use in non-human animal subjects, including, but not limited to, other primate species (e.g., monkeys, gorillas, etc.), canine species, feline species, reptile species, bird species, and non-mammal marine/aquatic species.

The embodiments disclosed herein have pertained to the relational storing of information (pixel data, signal data, hash data, etc.). Within the context of this document, “relationally storing” refers to the preservation of structured data relationships between entities, e.g., the structured data relationships between pixel values and nerve signal values. Although the embodiments disclosed herein have been described in the context of a database 60 that relationally stores information, the database is merely just one exemplary implementation of a storage medium that stores information while preserving the structured data relationships between entities. As used herein, the term “database” is not limited to traditional relational database systems, but is intended to encompass any suitable storage medium or storage system capable of relationally storing information. This includes, but is not limited to, structured file systems (e.g., spreadsheets, CSV files, JSON or XML documents with relational references), columnar data formats (e.g., Parquet, ORC), graph databases, key-value stores configured with relational logic, knowledge graphs or triple stores (e.g., RDF), and custom in-memory or distributed data structures that preserve relationships among stored data elements. Accordingly, any system or medium that stores data in a manner that permits retrieval based on relationships or associations among different data elements may be considered a “database” for purposes of the present disclosure.

It is to be understood that, throughout this disclosure, the terms “first” and “second”, as used in the context of sequences of instances and signal values, are employed solely as arbitrary designations for distinguishing between similar elements (e.g., sequences, signals). These terms are not intended to imply any particular order or preference unless explicitly stated otherwise. Accordingly, a “first” element (e.g., first sequence of instances or first signal values) described herein could equally refer to an element later designated as “second” (e.g., second sequence of instances or second signal values) in the claims, and vice versa.

Implementation of the method and/or system of embodiments of the disclosure can involve performing or completing selected tasks manually, automatically, or a combination thereof. Moreover, according to actual instrumentation and equipment of embodiments of the method and/or system of the disclosure, several selected tasks could be implemented by hardware, by software or by firmware or by a combination thereof using an operating system.

For example, hardware for performing selected tasks according to embodiments of the disclosure could be implemented as a chip or a circuit. As software, selected tasks according to embodiments of the disclosure could be implemented as a plurality of software instructions being executed by a computer using any suitable operating system. In an exemplary embodiment of the disclosure, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present disclosure. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form, “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the disclosure.

Although the disclosure has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. A method for use with a subject having, a brain, at least one eye, and at least one nerve bundle connecting between the brain and the at least one eye, the method comprising:
at each instance of a first sequence of instances, utilizing a limiting arrangement to allow light from a different part of a scene within the field of view of the subject to be viewed by the at least one eye, by blocking light from all other parts of the scene from reaching the at least one eye;
receiving, for each instance of the first sequence of instances, a first signal value that corresponds to a nerve impulse transmission along the at least one nerve bundle in response to the subject viewing the part of the scene;
determining, for each first signal value, a corresponding pixel value based on: a plurality of pixel values and a plurality of signal values stored in a storage medium; and
reconstructing a digital image of the scene from the determined corresponding pixel value for each first signal value, the reconstructed image of the scene being representative of what the subject sees when viewing the scene with the at least one eye.

2. The method of claim 1, wherein the plurality of pixel values stored in the storage medium are derived from a subset of pixels of an image presented to the subject over a second sequence of instances, the image including a plurality of pixels each assuming a pixel value, wherein the pixel value of all pixels of the image outside of the subset is held constant over the second sequence of instances, and at each subsequent instance in the second sequence of instances the pixel value of the pixels in the subset is changed relative to the pixel value at a previous instance in the second sequence of instances, and wherein each signal value of the plurality of signal values is measured at a respective instance of the second sequence of instances, each signal value of the plurality of signal values corresponding to a nerve impulse transmission along the at least one nerve bundle in response to the subject viewing the image.

3. The method of claim 2, wherein the subset of the pixels includes a single pixel.

4. The method of claim 2, wherein the pixel value of all pixels of the image outside of the subset is held constant over the second sequence of instances such that the pixels outside of the subset are presented as white or black.

5. The method of claim 1, wherein the limiting arrangement sequentially limits different parts of the scene over the second sequence of instances from reaching the at least one eye such that different parts of the scene are sequentially viewable by the at least one eye.

6. The method of claim 5, wherein the limiting arrangement includes a partially transparent display.

7. The method of claim 5, wherein the limiting arrangement includes a holographic display.

8. The method of claim 1, wherein determining the corresponding pixel for each first signal value includes fitting each first signal value to a curve that represents a relationship between the plurality of pixel values and the plurality of signal values.

9. The method of claim 8, wherein fitting each first signal value to the curve includes performing one or more of: interpolation, extrapolation, and regression.

10. (canceled)

11. A system for use with a subject having, a brain, at least one eye, and at least one nerve bundle connecting between the brain and the at least one eye, the system comprising:
a limiting arrangement deployed relative to the subject and a scene within the field of view of the subject, the limiting arrangement configured to allow, at each instance of a first sequence of instances, light from a different part of the scene to reach the at least one eye, by blocking light from all other parts of the scene from reaching the at least one eye; and
a processing subsystem configured to:
receive, for each instance of the first sequence of instances, a first signal value that corresponds to a nerve impulse transmission along the at least one nerve bundle in response to the subject viewing the part of the scene,
determine, for each first signal value, a corresponding pixel value based on: a plurality of pixel values and a plurality of signal values stored in a storage, and
reconstruct an image of the scene from the determined corresponding pixel value for each first signal value, the reconstructed image of the scene being representative of what the subject sees when viewing the scene with the at least one eye.

12. The system of claim 11, further comprising: a storage medium in communication with the processing subsystem, the storage medium storing the plurality of pixel values and the plurality of second signal values, wherein the plurality of pixel values are derived from a subset of pixels of an image presented to the subject over a second sequence of instances, the image including a plurality of pixels each assuming a pixel value, wherein the pixel value of all pixels of the image outside of the subset is held constant over the second sequence of instances, and at each subsequent instance in the second sequence of instances the pixel value of the pixels in the subset is changed relative to the pixel value at a previous instance in the second sequence of instances, and wherein each signal value of the plurality of signal values is measured at a respective instance of the second sequence of instances, each signal value of the plurality of signal values corresponding to a nerve impulse transmission along the at least one nerve bundle in response to the subject viewing the image.

13. The system of claim 12, wherein the subset of the pixels includes a single pixel.

14. The system of claim 12, wherein the pixel value of all pixels of the image outside of the subset is held constant over the second sequence of instances such that the pixels outside of the subset are presented as white or black.

15. The system of claim 11, wherein the limiting arrangement sequentially limits different parts of the scene over the first sequence of instances from reaching the at least one eye such that different parts of the scene are sequentially viewable by the at least one eye.

16. The system of claim 15, wherein the limiting arrangement includes a partially transparent display.

17. The system of claim 15, wherein the limiting arrangement includes a holographic display.

18. The system of claim 11, wherein the processing subsystem is configured to determine the corresponding pixel for each first signal value by fitting each first signal value to a curve that represents a relationship between the plurality of pixel values and the plurality of signal values.

19. The system of claim 18, wherein fitting each first signal value to the curve includes the processing subsystem performing one or more of: interpolation, extrapolation, and regression.

20. (canceled)

21. A method for use with a subject having, a brain, at least one eye, and at least one nerve bundle connecting between the brain and the at least one eye, the method comprising:
presenting an image to the subject at a first sequence of instances, wherein the image includes a plurality of pixels each assuming a pixel value, and wherein the image is presented to the subject such that: i) all but a subset of the pixels are held at a constant pixel value over the first sequence of instances, and ii) at each subsequent instance in the first sequence of instances the pixel value of the pixels in the subset of pixels is changed relative to the pixel value at a previous instance in the first sequence of instances such that there is a plurality of pixel values corresponding to the first sequence of instances;
receiving, for each instance of the first sequence of instances, a first signal value that corresponds to a nerve impulse transmission along the at least one nerve bundle in response to the subject viewing the pixel, such that there is a plurality of first signal values corresponding to the plurality of pixel values; and
storing, in a storage medium, the plurality of pixel values and the plurality of first signal values to provide a function for converting between pixel values and signal values.

22. The method of claim 21, further comprising:
at each instance of a second sequence of instances, allowing a different part of a scene within the field of view of the subject to be viewed by the at least one eye;
receiving, for each instance of the second sequence of instances, a second signal value that corresponds to a nerve impulse transmission along the at least one nerve bundle in response to the subject viewing the part of the scene; and
determining, for each second signal value, a corresponding pixel value based on the stored plurality of pixel values and the plurality of first signal values.

23. The method of claim 21, wherein presenting the image to the subject and receiving the first signal value is repeated for different subsets of pixels.
